(19) United States
(12) Patent Application Publication
(10) Pub. No.: US 2010/0316904 A1
(43) Pub. Date: Dec. 16, 2010

(54) Self flame-retardant lithium ion battery and case thereof made of plastic with helogens

(76) Inventor: Gui Ping Zhang, Shengzhen (CN)

Correspondence Address: SAM CHEN, 7F-1, 293, ROOSEVELT ROAD, SEC 3, TAIPEI, TW

(21) Appl. No.: 12/483,218

(22) Filed: Jun. 11, 2009

(51) Int. Cl. H01M 2/02

(52) U.S. Cl. 429/163

(57) ABSTRACT

A self flame-retardant lithium ion battery and case thereof formed of plastic with halogens are provided. In one embodiment, the plastic with halogens is selected from the group consisting of PVC (polyvinyl chloride), PVDF (polyvinylidene fluoride), PTFE (polytetrafluoethylene), CPVC (chlorinated polyvinyl chloride), CPE (chlorinated polyethylene), and any combinations thereof. In another embodiment, the plastic with halogens is a mixture of a first material selected from the group consisting of PVC, PVDF, PTFE, CPVC, CPE, and any combinations thereof, and a second material selected from the group consisting of PP (polypropylene), PE (polyethylene), PB (polybutylene), and any combinations thereof. Electrolyte in the battery has hexamethyldisilazane (HMDS).

### BACKGROUND OF THE INVENTION

1. Field of Invention

The invention relates to lithium ion batteries and more particularly to such a self flame-retardant lithium ion battery and case thereof formed of plastic with halogens having other improved characteristics including decreased manufacturing cost and increased tensile strength and lifespan.

2. Description of Related Art

Electrolysis is the passage of an electric current through an ionic substance that is, for example, dissolved in a suitable solvent, resulting in chemical reactions at both electrodes and separation of materials.

Lithium ion battery is a kind of electrolytic cell. It is required that no water and no oxygen exist in the case thereof. Otherwise, the lithium ion battery may be poor in performance or even fail. Hence, the selection of the battery case materials and how to sealingly construct the battery case are very important in the art.

Conventionally, the case of a lithium ion battery is made of aluminum, stainless steel, or laminated aluminum foil so as to contain electrolyte in a corrosion-free and leak free fashion. For both aluminum and stainless steel battery cases, cover, bottom, and peripheral section thereof are secured together by laser. For the laminated aluminum foil battery case, cover, bottom, and peripheral section thereof are secured together by heating in a high pressure manufacturing process.

High capacity batteries are gaining popularity due to great demand in portable electronic products and electric vehicles. For example, the specifications of a battery can be 10 Ah (Ampere-hour), 100 Ah, or even 1,000 Ah with safety being not sacrificed.

It is understood that high strength case is required for all high capacity batteries. However, above three materials for constructing the battery case are unsatisfactory as detailed below.

For battery case made of laminated aluminum foil or aluminum which has lower rigidity, anode and cathode of the battery may expand or contract after a relatively short period time of use (i.e., the times of charging and discharging being allowed to perform is small). It is also known that gaseous products may bubble from the electrolyte during electrolysis. These gaseous products can exert a great pressure on the battery case, resulting in a permanent deformation of the case.

For a battery case made of stainless steel and having a shape of parallelepiped, the case tends to swell on its four side surfaces because anode and cathode of the battery may expand or contract after a relatively short period time of charging and discharging. In addition, stainless steel is relatively heavy due to higher density than plastics. Moreover, separators in the battery may be damaged by high temperature in the high cost laser sealing process. Thus, the need for improvement still exists. There have been numerous suggestions in prior patents for lithium ion battery. For example, U.S. Pat. No. 7,306,880 describes electrolyte for a lithium ion battery and a lithium ion battery comprising the same.

### SUMMARY OF THE INVENTION

It is therefore one object of the invention to provide a self flame-retardant lithium ion battery and case thereof. The case is formed of plastic with halogens so as to have advantages including being self flame-retardant, higher rigidity due to increased tensile strength, decreased manufacturing cost, and prolonged lifespan.

The above and other objects, features and advantages of the invention will become apparent from the following detailed description taken with the accompanying drawings.

### BRIEF DESCRIPTION OF THE DRAWINGS

FIG. 1 is a perspective view of a first preferred embodiment of lithium ion battery according to the invention;

FIG. 2 is a perspective view of a second preferred embodiment of lithium ion battery according to the invention;

FIG. 3 is a table showing color change or not with respect to the electrolyte without hexamethyldisilazane being added to and the electrolyte with hexamethyldisilazane being added to when chemical reactions of the electrolyte occur at different temperatures for different periods of time as comparisons according to the invention; and

FIG. 4 is a table showing various properties for the battery case made of plastic with halogens according to the invention and the other conventional battery cases made of laminated aluminum foil, aluminum, stainless steel, and plastic without halogens as comparisons.

### DETAILED DESCRIPTION OF THE INVENTION

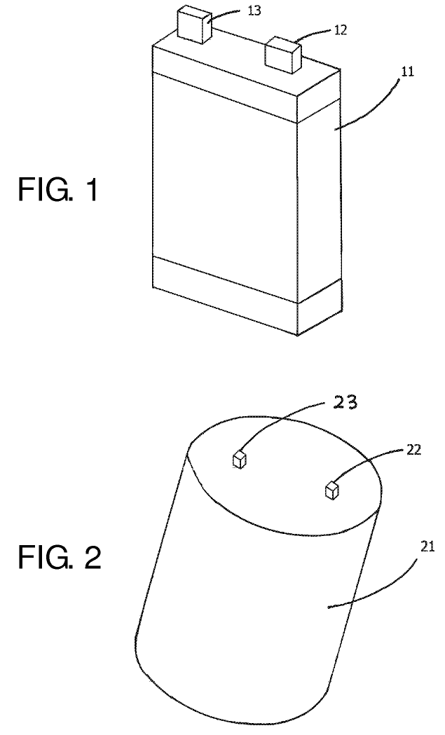

Referring to FIG. 1, a lithium ion battery in accordance with a first preferred embodiment of the invention is shown. The lithium ion battery comprises a rectangular case 11 with electrolyte contained therein, a positive electrode 12 on a cover, and a negative electrode 13 also on the cover.

Referring to FIG. 2, a lithium ion battery in accordance with a second preferred embodiment of the invention is shown. The lithium ion battery comprises a cylindrical case 21 with electrolyte contained therein, a positive electrode 22 on a cover, and a negative electrode 23 also on the cover. Each of the cases 11, 21 is made of plastic with halogens. The following discussion will be directed to the case 11 only for purpose of brevity only.

The plastic with halogens may be selected from PVC (polyvinyl chloride), PVDF (polyvinylidene fluoride), PTFE (polytetrafluoethylene), CPVC (chlorinated polyvinyl chloride), CPE (chlorinated polyethylene), or a combination of any two of them. Alternatively, the plastic with halogens is a mixture of a first material selected from PVC, PVDF, PTFE, CPVC, CPE, or a combination of any two of them, and a second material selected from PP (polypropylene), PE (polyethylene), PB (polybutylene), or a combination of any two of them.

A first exemplary example of the compositions of plastic with halogens is 100 wt % of PVC. A second exemplary example of the compositions of plastic with halogens is 50 wt % of PTFE and 50 wt % of PVDF. A third exemplary example of the compositions of plastic with halogens is 90 wt % of CPE and 10 wt % of PP. A fourth exemplary example of the compositions of plastic with halogens is 0.1 wt %, 50 wt % or 99.9 wt % of CPE with the remaining compositions being CPVC. A fifth exemplary example of the compositions of plastic with halogens is 0.1 wt %, 50 wt % or 99.9 wt % of CPE with the remaining compositions being PVC.

PVC is a widely used thermoplastic polymer. Worldwide, over 50% of PVC manufactured is used in construction. As a building material, PVC is cheap, durable, and easy to assemble. PVC can be made softer and more flexible by the addition of plasticizers, the most widely-used being phthalates. In this form, it is used in clothing and upholstery, and to make flexible hoses and tubing, flooring, to roofing membranes, and electrical cable insulation. It is also commonly used in figurines and in inflatable products such as waterbeds, pool toys, and Inflatable structures.

The case 11 and cover and bottom of the lithium ion battery can be manufactured (i) separately and secured together by applying PVC adhesive bonding, or (ii) integrally. For (i), the case 11 and cover and bottom of the lithium ion battery having mating joining portions are preferred. PVC adhesive can be prepared by mixing PVC plastic or PVC resin with suitable solvent such as cyclohexanone, tetrahydrofuran, or cyclohexane.

A first exemplary example of the compositions of PVC adhesive is 50 wt % of cyclohexanone, 5 wt % of PVC plastic, and 45 wt % of tetrahydrofuran. A second exemplary example of the compositions of PVC adhesive is 3 wt % of PVC resin, 10 wt % of E-51 epoxy resin, 3 wt % of dioctyl phthalate, 55 wt % of cyclohexanone, 24 wt % of toluene, and 5 wt % of polyethylene polyamine. The second exemplary example of the compositions of PVC adhesive has an increased adhesive strength as compared with the first exemplary example of the compositions of PVC adhesive.

A third exemplary example of the compositions of PVC adhesive is 55 wt % of CPVC, 15 wt % of tetrahydrofuran, 15 wt % of cyclohexane, and 15 wt % of 2-butanone. This exemplary example of the compositions of PVC adhesive has the advantages of increased adhesive strength, improved watertight-ness, and quick adhesion.

A fourth exemplary example of the compositions of PVC adhesive is 20 wt % of PVC resin, 38 wt % of tetrahydrofuran, 38 wt % of cyclohexane, and 4 wt % of dibutyl phthalate. This exemplary example of the compositions of PVC adhesive has the advantage of increased collision resistance. In brief, it substantially has the same advantageous benefits as the plastic with halogens according to the invention for the manufacturing of the battery case.

Moreover, other additives may be added to the PVC adhesive. For example, hardening such as (i) either a combination of epoxy resin and fatty amine (ii) or a combination of epoxy resin and aromatic amine may be used. Fatty amine is either 1,2-ethylenediamine or diethylenetriamine. Aromatic amine is m-phenylenediamine. Also, plasticizer such as dibutyl phthalate or dioctyl phthalate may be used.

PVC plastic or PVC resin has a weight percentage in the range of 0.01 wt % to 49.9 wt % such as 0.01 wt %, 20 wt %, or 49.9 wt %. Hardening has a weight percentage in the range of 0.01 wt % to 19.9 wt % such as 0.01 wt %, 9.0 wt %, or 19.9 wt %. Plasticizer has a weight percentage in the range of 0.01 wt % to 15.0 wt % such as 0.01 wt %, 5.0 wt %, or 15.0 wt %.

PVC adhesive is advantageous for having a strong adhesion. Thus, the lithium ion battery having a battery case 11 made of plastic with halogens has the advantages of being leak proof, self flame-retardant, resistant to pressure, and difficult of being deformed according to the invention. Moreover, the lithium ion battery can be manufactured in a simple process and the lithium ion battery has a capacity of 10 Ah, 40 Ah, 100 Ah, or even 1,000 Ah. The lithium ion battery is particularly suitable for being used as the battery of an electric vehicle (e.g., electric car).

Working temperature of electrolyte of a typical lithium ion battery is limited to no more than 60° C. Otherwise, undesired effects can occur as detailed below. Water components of the electrolyte can react with lithium hexafluorophosphate thereof. As a result, colorless hydrofluoric acid and gaseous products are generated. However, the color of the electrolyte changes due to the reaction of lithium hexafluorophosphate with water components. The gaseous products can adversely expand the battery case (i.e., bulges). It is also understood that a chemical reaction of the electrolyte of typical lithium ion battery of a car may occur at a temperature more than 80° C. Hence, the above two adverse effects are impossible of being eliminated by the current technologies.

Advantageously, silazane (e.g., 0.000,000,1 wt % to 10 wt % of hexamethyldisilazane (HMDS)) is added to the liquid electrolyte contained in the lithium ion battery of the invention. Si—N bonds of HMDS can react with water components of the electrolyte. As a result, ammonia (NH₃) is generated. NH₃ in turn reacts with lithium hexafluorophosphate. That is, there are no water components in electrolyte after HMDS is added to the liquid electrolyte. Hence, no hydrofluoric acid is generated. As a result, no color change of the electrolyte occurs and no gaseous products are generated (i.e., abnormal expansion of the battery case is eliminated) even when the electrolyte of the lithium ion battery of the invention for a car is subject to a temperature more than 60° C. Moreover, shelf life of the lithium ion battery of invention is prolonged greatly.

The electrolyte of the lithium ion battery has solvent (e.g., EC (ethylene carbonate), EMC (ethyl methyl carbonate), PC (propylene carbonate), DMC (dimethyl carbonate), DEC (diethyl carbonate), MPC (methyl carbonate), propyl butyrate, ethyl butanoate, ethyl acetate, γ-butyrolactone); lithium hexafluorophosphate; and additive (e.g., PS (1,3-propane sultone), VC (vinylene carbonate), VEC (vinyl ethylene carbonate), glycol sulfite, tris(trimethylsilyl)borate, or tris(trimethylsilyl)phoshate). The concentration of lithium hexafluorophosphate is in the range of 0.5 mol to 2.1 mol.

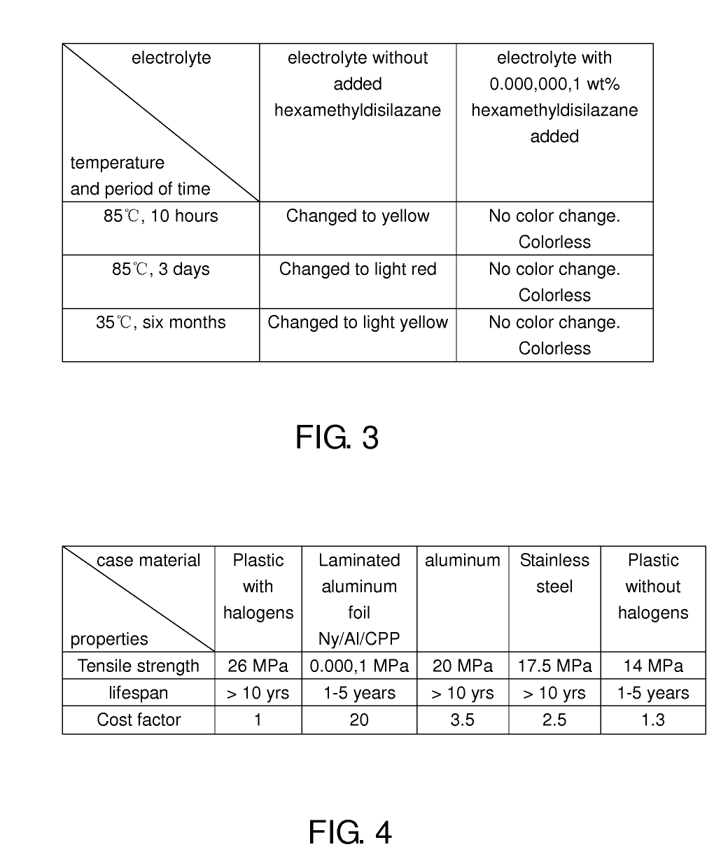

Referring to FIG. 3, it is a table showing color change or not with respect to the electrolyte without hexamethyldisilazane being added to and the electrolyte with 0.000,000,1 wt % of hexamethyldisilazane being added to when chemical reactions of the electrolyte occur at different temperatures for different periods of time as comparisons according to the invention. As shown, in the central column of the table for the electrolyte without hexamethyldisilazane being added to color of the electrolyte changes to yellow when the electrolyte was kept in a temperature of 85° C. for ten hours; color of the electrolyte changes to light red when the electrolyte was kept in a temperature of 85° C. for three days; and color of the electrolyte changes to light yellow when the electrolyte was kept in a temperature of 35° C. for six months respectively.

As shown in the right column of the table for the electrolyte with hexamethyldisilazane being added to color of the electrolyte remains unchanged (i.e., colorless) when the electrolyte was kept in a temperature of 85° C. for ten hours; color of the electrolyte remains unchanged (i.e., colorless) when the electrolyte was kept in a temperature of 85° C. for three days; and color of the electrolyte remains unchanged (i.e., colorless) when the electrolyte was kept in a temperature of 35° C. for six months respectively.

Referring to FIG. 4, it is a table showing various properties for the battery case made of plastic with halogens according to the invention and the other conventional battery cases made of laminated aluminum foil, aluminum, stainless steel, and plastic without halogens as comparisons. It is seen that the battery case of the invention (i.e., the battery case made of plastic with halogens) is better than the other four types of conventional battery case in terms of tensile strength (i.e., rigidity) and lifespan. Further, the battery case of the invention has a lowest cost factor among them.

Moreover, the plastic with halogens of the invention can also be employed as the material of manufacturing the battery case of lithium cobalt oxide battery, lithium manganese oxide battery, lithium nickel cobalt manganese composite oxide battery, lithium iron phosphate battery, lithium manganese silicate battery, or lead acid battery.

While the invention herein disclosed has been described by means of specific embodiments, numerous modifications and variations could be made thereto by those skilled in the art without departing from the scope and spirit of the invention set forth in the claims.

What is claimed is:

1. A lithium ion battery comprising:
a case for containing electrolyte;
a positive electrode mounted on the case; and
a negative electrode mounted on the case,
wherein the case is formed of plastic with halogens.

2. The lithium ion battery of claim 1, wherein the plastic with halogens is selected from the group consisting of PVC (polyvinyl chloride), PVDF (polyvinylidene fluoride), PTFE (polytetrafluoethylene), CPVC (chlorinated polyvinyl chloride), CPE (chlorinated polyethylene), and any combinations thereof.

3. The lithium ion battery of claim 2, wherein each of PVC, PVDF, PTFE, CPVC, CPE, and any combinations thereof has a weight percentage of 0.1 to 99.9.

4. The lithium ion battery of claim 1, wherein the plastic with halogens is a mixture of a first material selected from the group consisting of PVC, PVDF, PTFE, CPVC, CPE, and any combinations thereof, and a second material selected from the group consisting of PP (polypropylene), PE (polyethylene), PB (polybutylene), and any combinations thereof.

5. The lithium ion battery of claim 4, wherein each of PVC, PVDF, PTFE, CPVC, CPE, and any combinations thereof has a weight percentage of 0.1 to 99.9; and each of PP, PE, PB, and any combinations thereof has a weight percentage of 0.1 to 99.9.

6. The lithium ion battery of claim 2, wherein CPE of the plastic with halogens has a weight percentage of 0.1 to 99.1 and a remaining composition thereof is CPVC.

7. The lithium ion battery of claim 2, wherein CPE of the plastic with halogens has a weight percentage of 0.1 to 99.1 and a remaining composition thereof is PVC.

8. The lithium ion battery of claim 1, wherein the case is assembled together by applying PVC adhesive.

9. The lithium ion battery of claim 8, wherein the PVC adhesive is prepared by mixing PVC plastic or PVC resin with solvent selected from the group consisting of cyclohexanone, tetrahydrofuran, and cyclohexane; and wherein the PVC plastic or the PVC resin has a weight percentage of 0.01 to 49.9.

10. The lithium ion battery of claim 9, further comprising adding hardening to the PVC adhesive.

11. The lithium ion battery of claim 10, wherein the hardening is (i) either a combination of epoxy resin and fatty amine (ii) or a combination of epoxy resin and aromatic amine; and wherein the hardening has a weight percentage of 0.01 to 19.9.

12. The lithium ion battery of claim 11, wherein the fatty amine is either 1,2-ethylenediamine or diethylenetriamine.

13. The lithium ion battery of claim 11, wherein the aromatic amine is m-phenylenediamine.

14. The lithium ion battery of claim 9, further comprising adding plasticizer to the PVC adhesive.

15. The lithium ion battery of claim 14, wherein the plasticizer is either dibutyl phthalate or dioctyl phthalate; and wherein the plasticizer has a weight percentage of 0.01 to 15.0.

16. The lithium ion battery of claim 8, wherein the PVC adhesive is prepared by mixing PVC plastic having a weight percentage of 5 with cyclohexanone having a weight percentage of 50 and tetrahydrofuran having a weight percentage of 45.

17. The lithium ion battery of claim 8, wherein the PVC adhesive is prepared by mixing PVC resin having a weight percentage of 3 with E-51 epoxy resin having a weight percentage of 10, dioctyl phthalate having a weight percentage of 3, cyclohexanone having a weight percentage of 55, toluene having a weight percentage of 24, and polyethylene polyamine having a weight percentage of 5.

18. The lithium ion battery of claim 8, wherein the PVC adhesive is prepared by mixing CPVC having a weight percentage of 55 with tetrahydrofuran having a weight percentage of 15, cyclohexane having a weight percentage of 15, and 2-butanone having a weight percentage of 15.

19. The lithium ion battery of claim 8, wherein the PVC adhesive is prepared by mixing PVC resin having a weight percentage of 20 with tetrahydrofuran having a weight percentage of 38, cyclohexane having a weight percentage of 38, and dibutyl phthalate having a weight percentage of 4.

20. The lithium ion battery of claim 8, wherein the electrolyte has hexamethyldisilazane (HMDS) having a weight percentage of about 0.000,000,1 to 10.
